(19) United States
(12) Patent Application Publication
(10) Pub. No.: US 2024/0408842 A1
(43) Pub. Date: Dec. 12, 2024

(54) Absorption and Retention Systems for Vehicle Leaks

(71) Applicant: Anthony C. Wetzel, Akron, OH (US)

(72) Inventor: Anthony C. Wetzel, Akron, OH (US)

(21) Appl. No.: 18/805,894

(22) Filed: Aug. 15, 2024

Related U.S. Application Data
(62) Division of application No. 18/297,248, filed on Apr. 7, 2023, now abandoned.
(60) Provisional application No. 63/329,946, filed on Apr. 12, 2022.

(51) Int. Cl. B32B 5/26; B32B 3/04; B32B 5/02

(52) U.S. Cl. CPC B32B 5/269; B32B 3/04; B32B 5/022; B32B 2250/02; B32B 2250/20; B32B 2262/0253; B32B 2307/7265; B32B 2432/00

(57) ABSTRACT

An absorption and retention system for vehicle leaks consists of a top absorbent pad received by a bottom layer, the two being fused together. The combination of top pad and bottom layer are geometrically configured to be removably attached by wires to the undercarriage of a vehicle and to be positioned for receiving leaks from the vehicle and being of a geometric configuration to avoid interference with any operative portions of the vehicle such as wheels or the like. The pad is adaptable for receiving any of numerous liquids, including lubricants, hydraulic fluids, coolants and the like. The top pad may be of absorbent polypropylene and the bottom film of a suitable flexible and impermeable plastic or spunbond polypropylene fabric. A mechanic pad facilitates implementation of the absorption and retention system.

### CROSS REFERENCE TO RELATED APPLICATION

This application is a divisional of pending U.S. patent application Ser. No. 18/297,248, filed Apr. 7, 2023, which claimed priority to U.S. Provisional Patent Application Ser. No. 63/329,946, filed Apr. 12, 2022.

### TECHNICAL FIELD

The invention herein resides in the art of containing fluid leaks in units employing fluids for power transmission, lubrication, cooling and the like. More particularly, the invention relates to a system for preventing leakage attendant to such units from reaching the ground or other supportive surfaces for the unit. Specifically, the invention relates to an absorbent pad configured for receipt by the unit in the specific regions of the unit most prone to such leaks. More specifically, the invention relates to a configured, disposable, absorbent pad adapted for removable securement to the underside of vehicles prone to leakage, such as cement mixer trucks, tow trucks, truck tractors and the like. The invention further contemplates a mechanic's work mat for placement beneath or alongside a vehicle and upon which an individual can lay while servicing the vehicle or implementing the leakage prevention system.

### BACKGROUND OF THE INVENTION

The leaking of fluid from vehicles is a commonly known problem. Fluid leakage from large, powerful, heavy-duty engines and hydraulic systems is often quite pronounced and can be significantly damaging to the environment and the surfaces leaked upon.

One of the most problematic vehicles for fluid leaks is cement mixers. They are particularly problematic because they are often called to deliver and mix cement in an area requiring that cement mixer truck to drive upon, or rest over, areas of finished surfaces, such as existing driveways or parking areas, landscaping or the like. The dripping of lubricant and hydraulic oils, coolants, and the like can be permanently damaging or, at the least, costly to repair. As to cement mixer trucks, the leaking is most exaggerated at the point of actual delivery and dispensing of the cement, where heavy loads are placed on both the vehicle engine and the hydraulic pumps and lines, at which time the propensity for leakage is intensified.

In the past, vehicle operators have often used cardboard, paper, rags, pads, dirt, snow, or anything available to cover the surface between the trucks to catch oil drippings. More recently, engine diapers, absorbent pads (square or rectangular) in the form of drip pads or mats have been employed.

Problems with the prior art are legion. Typically, absorbent pads or engine diapers are only square or rectangular, not configured for the area to be serviced or to accommodate wheel wells, pivoting wheels, and the like. Known diapers require pad inserts and are typically installed, as a function of configuration, just under the oil pan. Known diapers are typically configured for long-term use and are a semi-permanent attachment to the vehicle. Most known engine diapers require tools to apply the diaper to the vehicle or, in many cases, require a mechanic to undertake the task. Often times, the vehicle needs to be lifted to provide sufficient area for installation.

The prior art attempts at diapers or the like have been of substantial cost and difficulty in use. Indeed, presently known diapers for vehicles are simply pads of absorbent material, without a covering beneath the absorbent material to contain and prevent the passage of fluid from an otherwise saturated pad.

There is a need in the art for structures or systems for absorbing and retaining leakages of vehicle fluid that are larger and provide more coverage than prior art systems. There is a particular need for absorptive pads that extend substantially the entire area beneath the engine compartment of a vehicle with cut-out areas for accommodating wheel wells, pivoting wheels, and the like.

There is a further need in the art for absorption and retention pads for vehicles such as trucks and the like that are easy to install without the need for tools or special training. A further need in the art is for a system providing disposable absorption and retention systems for vehicle leaks that may be easily and quickly installed and removed on a job site.

The art is further in need of a system having at least two pads of different configurations, a first to be positioned beneath the engine compartment of the vehicle and the other beneath the hydraulic system of the vehicle, the two being uniquely configured for such purposes.

There is an additional need in the art for a mechanic's mat adapted for use with absorption and retention systems as aforesaid and for general usage in an effective, safe and comfortable manner.

There is further a need in the art for systems satisfying the deficiencies noted above and doing so in a cost-effective manner, using state-of-the-art materials and techniques.

### DISCLOSURE OF INVENTION

In light of the foregoing, it is a first aspect of the invention to provide fluid absorption and retention pads that are larger than heretofore, serving to cover an entire region of the engine undercarriage of the vehicle.

Another aspect of the invention is the provision of a system for absorption and retention of vehicle fluid that is geometrically configured to accommodate wheel wells while being maintained directly beneath the region most prone to fluid leakage.

Still another aspect of the invention is the provision of a fluid absorption and retention system for vehicle leaks, which may be installed without the use of tools or a specific skill.

Yet another aspect of the invention is the provision of an absorption and retention system for vehicle leaks that includes a pad that is easily installed and removed on the job site and which is of a disposable nature.

Still an additional aspect of the invention is the provision of an absorption and retention system for vehicle leaks that provides multiple pads, one uniquely configured for receipt beneath the engine, and at least one other for receipt below other areas prone to leakage such as hydraulic pumps and lines.

A further aspect of the invention is the provision of an absorption and retention system for vehicle leaks that is cost-effective and readily implemented with state-of-the-art materials.

The foregoing and other aspects of the invention that will become apparent herein are achieved by an absorption and retention system for vehicle leaks, comprising: a top absorbent pad; a bottom flexible, impermeable, plastic film congruently receiving said top absorbent pad; and wherein said bottom flexible, impermeable, plastic film has a continuous edge wrapped around a continuous edge of said top absorbent pad and bonded to a top surface of said top absorbent pad.

Other aspects of the invention are achieved by an absorption and retention system for vehicle leaks, comprising: a top layer of absorbent polypropylene material; a bottom layer of spunbond ultra-lightweight polypropylene fabric, said top and bottom layers being attached together; and wherein said pad is sized and configured to be received beneath an area of a vehicle prone to leakage and removably forming a pad attached to an undercarriage of the vehicle.

### BRIEF DESCRIPTION OF THE DRAWINGS

For a complete understanding of the various aspects, structures, and techniques of the invention, reference should be made to the following detailed description and accompanying drawings, wherein:

FIG. 1 is a top plan view of a first absorption and retention pad configured for placement under the engine carriage of a vehicle and having cut-out areas to accommodate the front wheel wells;

FIG. 2 is a cross-sectional view of the absorption and retention pad of FIG. 1, taken along the line 2-2;

FIG. 3 is a front elevational view of a wire employed for securing portions of the periphery of the pad of FIG. 1 to elements on the undercarriage of the vehicle;

FIG. 4 is an illustrative view of the application of the absorption and retention pad of the invention to a typical truck or the like;

FIG. 5 is a side elevational view of a cement mixer or truck as commonly known and employed for delivery and on-site mixing and dispensing of cement;

FIG. 6 is an illustrative illustration of the undercarriage of the cement truck of FIG. 5 showing the application of absorption and retention pads for each of the engine undercarriage and hydraulic system of the truck;

FIG. 7 is a top plan view of a second absorption and retention pad made in accordance with the concepts of the invention;

FIG. 8 is a cross-sectional view of the absorption and retention pad of FIG. 7, taken along the line 8-8;

FIG. 9 is a top plan view of a mechanic's work mat made in accordance with the invention;

FIG. 10 is a partial side sectional view of the mechanic's work mat of FIG. 9, taken along the line 10-10; and

FIG. 11 is a perspective of the mechanic's work mat of FIG. 9 rolled onto itself.

### BEST MODE AND PREFERRED EMBODIMENTS

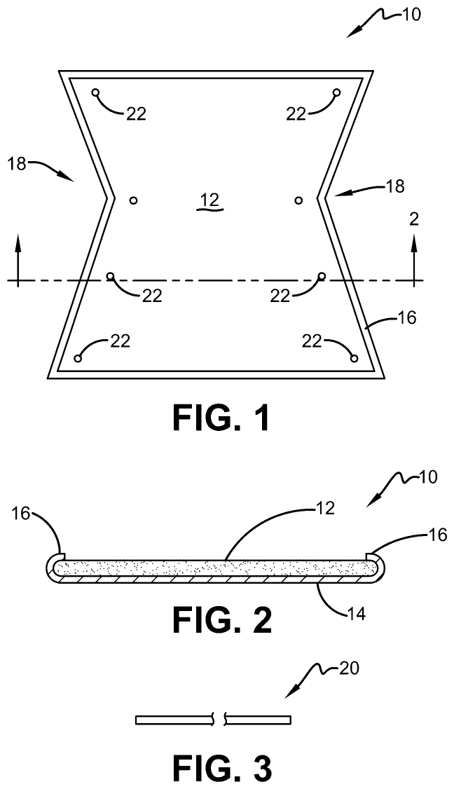

Referring now to the drawings and more particularly FIGS. 1 and 2, it can be seen that an absorption and retention pad made in accordance with a first embodiment of the invention is designated generally by the numeral 10. The absorption and retention pad 10 comprises a top absorbent pad 12 of a suitable absorptive material capable of capturing vehicle fluids such as lubrication oils, coolants, hydraulic fluids and the like. A preferred material is an absorbent polypropylene fabric, although cotton fabric may be acceptable. The bottom 14 of the pad 10 is preferably a flexible polymeric or plastic film that is impervious to the aforementioned vehicle fluids, thus capable of retaining such fluids in the event the top absorbent pad 12 becomes saturated or fluid otherwise passes therethrough.

With continued reference to FIGS. 1 and 2, it will be seen that the bottom flexible plastic film 14 is wrapped around the peripheral edges of the top absorbent pad 12, as designated by the numeral 16. The peripheral edges 16 are bonded to the top absorbent pad 12 by means of thermal bonding, adhesive attachment, or other suitable means. Preferably, the bonding is continuous about the entire periphery. Accordingly, the absorption and retention pad 10 are an integral unit of a top absorbent pad and a bottom flexible plastic film impervious to vehicle fluids, the two being bonded together in sealing engagement about the periphery of the pad. Of course, it will be appreciated that the pad 10 may comprise only the absorbent pad 12 without the flexible plastic film 14 if the pad 12 is of sufficient absorbency to ensure containment of fluid of the nature and volume of concern.

The particular embodiments of the pad 10 are of a generally rectangular nature corresponding to the undercarriage of a vehicle upon which it is to be used, but having cut-out regions or recesses 18 on the lateral sides to accommodate the wheel wells and pivoting or turning activity of the associated wheels from engaging and possibly damaging the pad 10.

As shown in FIG. 3, wires 20 may be used of a suitable metal or the like and are used for securing the pad 10 to various elements about the undercarriage of the vehicle so as to position the pad 10 appropriately with respect to the engine housing and areas of possible fluid leakage. The wires 10 are strong enough to poke through the plastic film bottom 14 and the top absorbent pad 12 at areas such as designated by the numeral 22. The wires may then be wrapped around and twisted into securing engagement with various available elements characterizing the undercarriage. Any suitable wire having the necessary flexibility and strength for being pushed through the plastic layer 14 and fabric layer 12 and accommodating securement about an element of the undercarriage will be acceptable for accommodating both placement and removal of the pad 10 to the undercarriage. It has been found that wire of steel, aluminum, or copper, having a gauge of 10-20, may be suitable for such purposes. It is also contemplated that the wires 20 may be in the form of hook springs, secured at one end to the pad 10 and having a hook at the opposite to be placed over a suitable portion of the undercarriage.

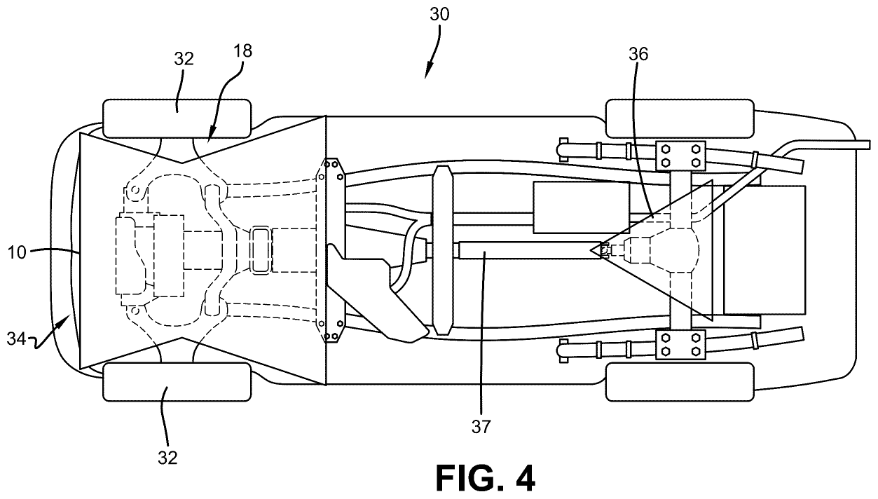

With reference now to FIG. 4, an appreciation of the implementation of the absorption and retention pad 10 on a box truck, van, tractor or the like may be seen. A representative undercarriage 30 of such a vehicle is illustrated as receiving the absorption and retention pad 10, secured by wires 20, beneath the engine compartment 34. The pad 10 has cut-out or recessed regions 18 to accommodate the wheels 32, as illustrated. It will be appreciated that the absorption and retention pad 10 fairly covers the entirety of the engine compartment 34 but for the regions 18 that are necessary for accommodating pivotal movement of the tires 32.

Also shown in FIG. 4 is the implementation of a triangular configured absorption and retention pad 36, similar in all respect to the pad 10, but of a different geometry. That geometry is such as to accommodate the joinder of a drive shaft 37 with a differential gear box 38. Again, pad 36 is secured to the undercarriage by appropriate wires 20 at available securing locations on the undercarriage.

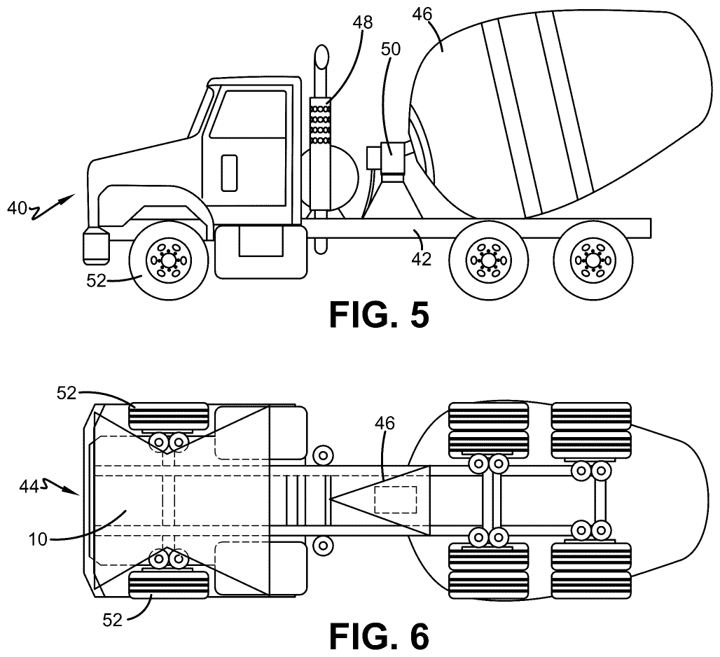

Referring now to FIGS. 5 and 6, it can be seen that the absorption and retention pad structures of the invention are particularly suitable for implementation with a cement mixer and delivery truck 40. In common fashion, the truck 40 is provided with a frame 42 supporting a cab 44 and associated engine compartment, a mixing drum 46, a water source 48, and a hydraulic system 50 with its associated hydraulic oil reservoir for controlling the drum 46. The absorption and retention pad 10, as discussed above, is fixed by wire 22 to various points on the undercarriage of the truck 42, positioning the pad 10 beneath the truck's engine, while accommodating space for pivoting of the wheels 52 while maneuvering the truck.

Also employed with the cement mixer and delivery truck is a triangular pad 46, as discussed above, specifically positioned beneath the hydraulic system and associated hydraulic oil reservoir 50. Again, the pad 46 is geometrically configured to be in receiving engagement with associated areas prone to leakage and is affixed by means of wires 22 to mounting points available on the undercarriage of the vehicle.

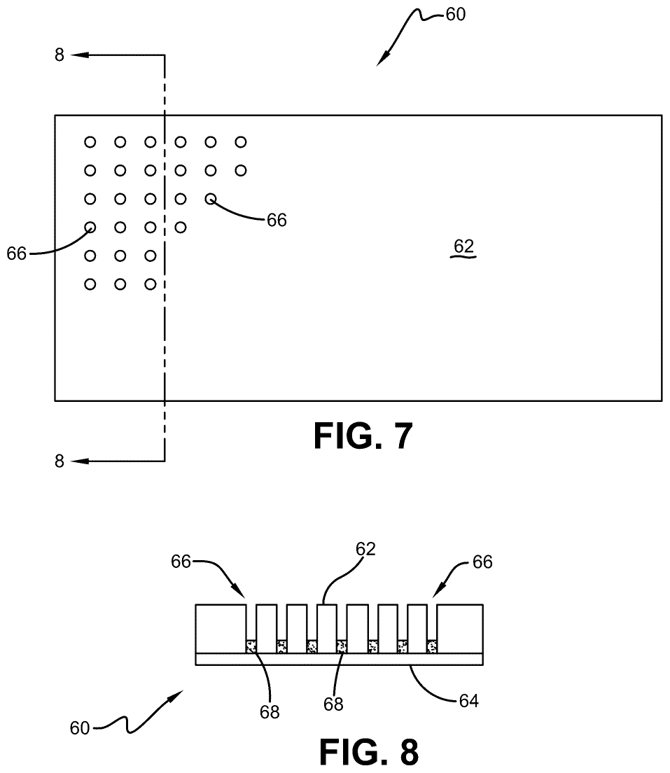

With reference to FIGS. 7 and 8, an appreciation can be obtained with regard to a second preferred embodiment of an absorption and retention pad 60 made in accordance with the invention. The geometric configurations and methods of use and disposal are consistent with those of the absorption and retention pad 10 discussed above. The physical composition of the pad 60, however, is different from that of the pad 10, as is the nature of performance.

The pad 60 has a top layer 62 of absorbent polypropylene material. The nature of the absorbent polypropylene material may be selected to be universally absorbent of water, grease, oil, coolants, acids, bases, and more. The absorbent polypropylene material may also be of the nature of “oil only” pads that are made of a meltblown polypropylene material. These “oil only” pads repel water while absorbing oil and petroleum-based fluids. Since it is known that common hydraulic fluids and many coolants are petroleum or oil based, the use of a meltblown polypropylene material can be employed such that water and the like is either repelled or passes through the “oil only” pad, while the oil or petroleum-based fluids and coolants are absorbed. Accordingly, the absorption capability of absorption and retention pad 60 is enhanced by using a meltblown polypropylene fabric for the top layer 62. The passage of water is seldom harmful to surroundings.

It is further contemplated that the absorption and retention pad 60 may be provided with a bottom layer 64 of a spunbond cover stock of ultra-lightweight polypropylene fabric. The layer 64 of such fabric adds a layer of strength and durability, particularly desired when meltblown polypropylene is employed as the absorbent layer 62. The spunbond cover stock of the bottom layer 64 is a chemically inert polypropylene that is attached to the top layer 62 as by compression or thermal bonding at the bottom of detents or recesses 66 resulting in compressed or melted fabric 68 at the bottom thereof and bonding to the bottom layer 64 of the spunbond cover stock.

The compression and/or thermal bonding as by the compressed or melted fabric 68 at the bottoms of the detents or recesses 66 eliminate the need for edge bonding or sealing 16 as between the absorbent pad 12 and the flexible plastic film 14 in the embodiment 10 as presented earlier herein.

Again, it will be appreciated that the geometric configurations of the pad 60, and the methods of securing as by means of wires 20, can be the same as discussed above with regard to the pad 10.

It will be appreciated that the specific size and geometry of the pads 10, 46, 60 will be dependent upon the various vehicles upon which they are used. In general, the various sizes can be configured to serve a wide range of vehicles, as between a small, medium, and large size availability. The primary goal is to ensure that all areas prone to leakage in the engine compartment and/or associated hydraulic fluid areas have a portion of the absorption and retention pad positioned where the leaks are most likely to drip.

The implementation and use of the invention is rather simple. The attachment of the absorption and retention pads can be effected immediately prior to their need, and removed when their use is no longer required. In the context of a cement mixing and delivery truck, the pads 10 and 46 and configured pads 60 may be readily applied immediately upon arrival at the job site, and can be removed for disposal or reuse after the dispensing of the cement has been completed and just before departure from the job site.

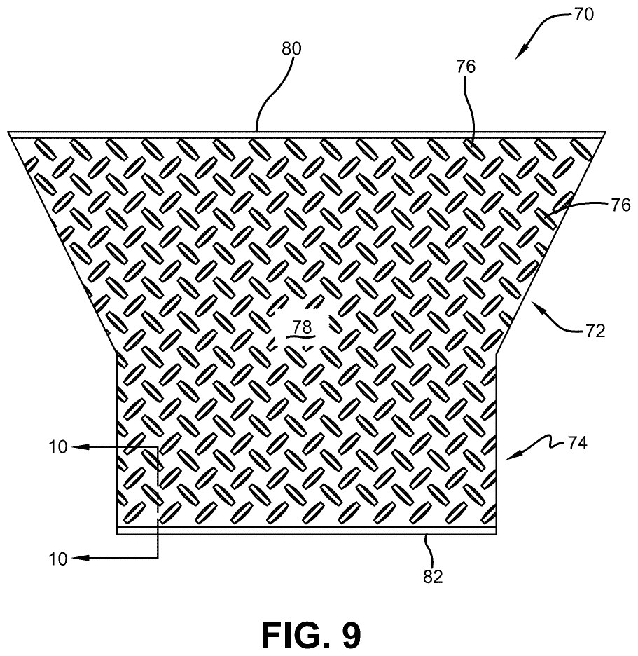

To facilitate the implementation and use of the absorption and retention pads discussed above, the invention herein also contemplates a mechanic work mat 70, best shown in FIGS. 9-11. The mechanic work 70 has an upper trapezoidal section 72 and a lower rectangular section 74. Most preferably, the sections 72, 74 are integral and continuous. Moreover, it is contemplated that the rectangular lower section 74 will, in most instances, be substantially square.

In substance, the mechanic work mat 70 comprises a rubber floor mat 78 having a plurality of uniformly spaced embossed protruding ridges 76 in what is known as a diamond plate configuration. This diamond plate configuration serves a number of purposes. It presents a number of barriers on the surface of rubber mat to prevent undesired rolling and/or loss of nuts, bolts, washers, or other small mechanical parts. The ridges also provide for a textured feel against the back of the mechanic or the like. A top edge plate 80 hems the longer run of the trapezoidal portion, while a bottom edge plate 82 finishes the bottom exposed edge of the rectangular section 74. It will be appreciated that most typically the trapezoidal section will receive the upper torso and arms of the mechanic or user, while the lower rectangular section accommodates the pelvis and legs.

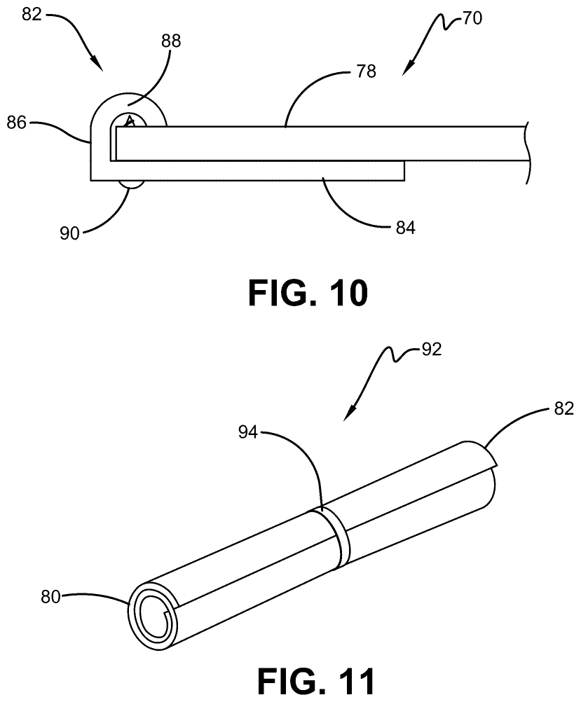

FIG. 10 provides a side illustration of the bottom edge plate 82, it being understood that the top and bottom edge plates 80, 82, are of substantially identical construction. Shown in FIG. 10, it can be seen that the bottom edge plate 82 is characterized by a flat horizontal plate portion 84, interconnected with a substantially vertical plate portion 86, which in turn extends into a curvate plate portion 88. The rubber floor mat 78 is secured to the flat horizontal plate portion 84 by means of appropriate fasteners 90 passing through the plate portion 84 and rubber floor mat 78, leaving an exposed end within the umbrella formed by the curvate plate 88. According to preferred embodiments, the fastener 90 may be a sheet metal screw accommodating the metallic structure of the edge plates 80, 82, as well as the rubber floor mat 78. The fastener 90 may be a sheet metal screw, a rivet, or the like. It will be appreciated that the vertical plate portion 86 and curvate plate 88 allow for foot traffic or the like over the edge plate 80, 82, without damaging the edge of the rubber mat 78.

As shown in FIG. 11, the invention also incorporates the feature of rolling up the mechanic work mat 70 into an appropriate roll 92, which is appropriately secured thereabout by an appropriate fastener, such as an elastic ring, “hook and loop” band, or the like.

The mechanic work mat can be readily stored and easily deployed onsite, allowing the driver or mechanic to lay there upon while fixing the various pads 10, 46, 60 in place.

Thus it can be seen that the various aspects of the invention have been achieved by the structure presented and described above. While in accordance with the patent statutes only the best mode and preferred embodiments of the invention has been presented and described in detail, the invention is not limited thereto or thereby. Accordingly, for an appreciation of the scope and breadth of the invention reference should be made to the following claims.

What is claimed is:

1. An absorption and retention system for vehicle leaks, comprising:
a top layer of absorbent polypropylene material;
a bottom layer of spunbond ultra-lightweight polypropylene fabric, said top and bottom layers being attached together; and
wherein said pad is sized and configured to be received beneath an area of a vehicle prone to leakage and removably forming a pad attached to an undercarriage of the vehicle.

2. The absorption and retention system for vehicle leaks as recited in claim 1, wherein said top layer comprises meltblown polypropylene material that repels water while absorbing oil and petroleum-based fluids.

3. An absorption and retention system for vehicle leaks as recited in claim 2, wherein recesses are formed in said top layer in bonding engagement with said bottom layer.
